(19) United States
(12) Patent Application Publication
(10) Pub. No.: US 2003/0031916 A1
(43) Pub. Date: Feb. 13, 2003

(54) Fuel cell electrode

(76) Inventors: Prathap Haridoss, Watervliet, NY (US); Chockkalingam Karuppaiah, Troy, NY (US); James F. McElroy, Suffield, CT (US); Glenn Eisman, Niskayuna, NY (US)

Correspondence Address: FISH & RICHARDSON PC, 225 FRANKLIN ST, BOSTON, MA, 02110, US

(21) Appl. No.: 09/727,748

(22) Filed: Nov. 30, 2000

(51) Int. Cl. H01M 4/86; H01M 4/92

(52) U.S. Cl. 429/40; 429/42

(57) ABSTRACT

A composition includes a catalyst, and a non-electrolytic material different than the catalyst, wherein the catalyst and the non-electrolytic material compose a fuel cell electrode.

### BACKGROUND

The invention relates to a composition that can be used, for example, in a fuel cell and/or a fuel cell stack.

A fuel cell can convert chemical energy to electrical energy by promoting a chemical reaction between two gases.

One type of fuel cell includes a cathode flow field plate, an anode flow field plate, a membrane electrode assembly disposed between the cathode flow field plate and the anode flow field plate, and two gas diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each flow field plate has an inlet region, an outlet region and open-faced channels connecting the inlet region to the outlet region and providing a way for distributing the gases to the membrane electrode assembly.

The membrane electrode assembly usually includes a solid electrolyte (e.g., a proton exchange membrane, commonly abbreviated as a PEM) between a first catalyst and a second catalyst. One gas diffusion layer is between the first catalyst and the anode flow field plate, and the other gas diffusion layer is between the second catalyst and the cathode flow field plate.

During operation of the fuel cell, one of the gases (the anode gas) enters the anode flow field plate at the inlet region of the anode flow field plate and flows through the channels of the anode flow field plate toward the outlet region of the anode flow field plate. The other gas (the cathode gas) enters the cathode flow field plate at the inlet region of the cathode flow field plate and flows through the channels of the cathode flow field plate toward the cathode flow field plate outlet region.

As the anode gas flows through the channels of the anode flow field plate, the anode gas passes through the anode gas diffusion layer and interacts with the anode catalyst. Similarly, as the cathode gas flows through the channels of the cathode flow field plate, the cathode gas passes through the cathode gas diffusion layer and interacts with the cathode catalyst.

The anode catalyst interacts with the anode gas to catalyze the conversion of the anode gas to reaction intermediates. The reaction intermediates include ions and electrons. The cathode catalyst interacts with the cathode gas and the reaction intermediates to catalyze the conversion of the cathode gas to the chemical product of the fuel cell reaction.

The chemical product of the fuel cell reaction flows through a gas diffusion layer to the channels of a flow field plate (e.g., the cathode flow field plate). The chemical product then flows along the channels of the flow field plate toward the outlet region of the flow field plate.

The electrolyte provides a barrier to the flow of the electrons and gases from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load and to the cathode flow field plate.

Electrons are formed at the anode side of the membrane electrode assembly, indicating that the anode gas undergoes oxidation during the fuel cell reaction. Electrons are consumed at the cathode side of the membrane electrode assembly, indicating that the cathode gas undergoes reduction during the fuel cell reaction.

For example, when hydrogen and oxygen are the gases used in a fuel cell, the hydrogen flows through the anode flow field plate and undergoes oxidation. The oxygen flows through the cathode flow field plate and undergoes reduction. The specific reactions that occur in the fuel cell are represented in equations 1-3.

H₂→2H⁺+2e⁻ (1)

1/2O₂+2H⁺+2e⁻→H₂O (2)

H₂+½O₂→H₂O (3)

As shown in equation 1, the hydrogen is reacted to form protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with the oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water, or other non conducting fluid) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

FIG. 1 shows a fuel cell system 20 including a fuel cell stack 30 having a plurality of fuel cells 35. Fuel cell system 20 also includes an anode gas supply 40, an anode gas inlet line 50, an anode gas outlet line 60, a cathode gas supply 65, a cathode gas inlet line 70, a cathode gas outlet line 80, a coolant inlet line 90, and a coolant outlet line 100.

To increase the electrical energy available, the plurality of fuel cells 35 can be arranged in series, to form fuel cell stack 30. For example, one side of a flow field plate functions as the anode flow field plate for one fuel cell while the opposite side of the flow field plate functions as the cathode flow field plate in another fuel cell. This arrangement may be referred to as a bipolar plate. The stack may also include plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

FIG. 2 is a schematic representation of fuel cell system 20 in operation. Anode gas supply 40, e.g., a reformer, provides in parallel hydrogen gas via inlet line 50 to the anodes of cells 1 through n. At each cell, the anode converts the hydrogen into protons and electrons. The protons travel through the solid electrolyte and to the cathode of the respective cells. At cell 1, the electrons flow toward an external load. At the other cells, the electrons flow to the cathode of an adjacent fuel cell, toward the external load (FIG. 2). Unreacted anode gas flows through the cells of fuel cell stack 30 through outlet 60.

Similarly, cathode gas supply 65, e.g., an air blower, provides in parallel oxygen (air) via inlet line 70 to the cathode of cells 1 through n. At each cell, the cathode forms water from the oxygen, protons from the respective anode, and electrons flowing from the external load (cell n) or adjacent anode (cell 1 through 1-n). The water is removed from stack 30 by the cathode gas stream. After flowing through the cells, the oxygen flows out of fuel cell stack 30 through outlet 80.

Thus, as the anode and cathode gases are supplied to fuel cell system 20, hydrogen and oxygen are converted into water, and electrons flow through the external load, thereby supplying electrical energy.

### SUMMARY

The invention relates to a composition that can be used, for example, in a fuel cell and/or a fuel cell stack.

During operation, a fuel cell system may be required to increase its power output nearly instantaneously, e.g., when a user increases power demand by suddenly operating more devices connected to the fuel cell system. This increased power demand generally requires an increased flow of oxygen and hydrogen to the cathodes and anodes, respectively. Without wishing to be bound by theory, it is believed that in these situations, sufficient oxygen can be delivered to the cathodes nearly instantaneously, e.g., by increasing the output of a blower. However, a hydrogen supply or production system (e.g., a fuel processor or reformer) can experience a lag, e.g., about 15-30 seconds, before it can produce sufficient hydrogen to meet the increased demand in power. Such lags can deprive the fuel cell system of hydrogen needed to produce the increased power demand, a situation sometimes called “fuel starvation”. A lag in the response time of a fuel processor may be referred to as a “reformer transient”. Lags in fuel supply can also be caused by factors such as valve blockage.

It is believed that during reformer transients, the polarity of one or more cells in the stack can be reversed by the effects of fuel starvation, potentially damaging the cells. For example, while some fuel cells continue to operate because they still contain excess fuel, one or more begin to operate as loads because they are nearly or completely out of hydrogen, i.e., fuel starved. These fuel starved fuel cells will reverse polarity.

For example, referring again to FIG. 2, during a reformer transient, cell 3 continues to operate normally, i.e., reacting fuel gases to produce power and water, but cell 2 is not operating normally because it is out of hydrogen. The anode of cell 3 continues to transfer electrons to the cathode of cell 2, but the anode of cell 2 is not producing enough electrons from hydrogen oxidation. As a result, the polarity of the electrodes will be reversed from normal operating conditions and/or the potential difference between the anode and the cathode of cell 2 can increase to relatively high oxidizing potentials, >about 0.6 Volts, or >about 1.23 Volts above a Standard Hydrogen Electrode (SHE). At this potential, the anode of cell 2 interacts with water to produce protons, electrons and oxygen (H₂O→2H⁺+2e⁻+½O₂). The protons migrate toward the cathode of cell 2, and the electrons migrate toward the cathode of cell 1, as in the normal fuel cell process.

However, the relatively high oxidizing potential and the evolution of oxygen at the anode of cell 2 can oxidize and degrade materials in the fuel cell, such as, for example, certain anode catalysts (e.g., ruthenium), catalyst supports (e.g., carbon), and carbon in the gas diffusion layer. These oxidizing conditions can lead to irreversible damage by reducing the electrochemical active area available at the anode, thereby leading to a loss in fuel cell performance.

The invention features an electrode composition tolerant to fuel cell starvation during reformer transients. The composition eliminates the use of a support susceptible to oxidation during reformer transients and may include an oxidation-resistant support material. The composition can also include a non-electrolytic binder to bond the catalyst. Without wishing to be bound by theory, it is believed that the binder prevents migration of protons. It is further believed that the binder, which generally does not shrink or swell, provides a good contact interface between the catalyst particles and between the anode and the solid electrolyte. By restricting proton migration, the binder may also limit the oxidation of materials due to breakdown of water, except at the catalyst-electrolyte interface. That is, the binder may stop the reaction H₂O→2H⁺+2e⁻+½O₂ from occurring on elements subject to oxidation.

In one aspect, the invention features a composition having a catalyst and a non-electrolytic material different than the catalyst, wherein the catalyst and the non-electrolytic material compose a fuel cell electrode. The composition can further include a first material resistant to oxidation up to about 3.0 Volts vs. SHE.

In one aspect, the invention features a composition having a catalyst and a first material resistant to oxidation up to about 3.0 Volts vs. SHE, wherein the catalyst and the first material compose a fuel cell electrode.

Embodiments of the invention may include one or more of the following features.

The electrode composition can include between about 75-95 wt % catalyst with the non-electrolytic material making up the balance. The catalyst portion may include between about 5-95 wt % of the material resistant to oxidation up to about 3.0 Volts vs. SHE.

The catalyst is capable of undergoing reversible oxide formation. The catalyst is capable of catalyzing oxidation of a fuel cell gas such as one having hydrogen. The catalyst can be selected from a group consisting of platinum, ruthenium, iridium, rhodium, palladium, molybdenum and alloys thereof. The catalyst can be distributed on the first material, e.g., with a load between about 5 percent and about 95 percent.

The first material may include an oxide, such as tungsten oxide, zirconium oxide, niobium oxide, and tantalum oxide.

The non-electrolytic material may include polytetrafluoroethylene or a fluorine-containing resin, such as a copolymer of tetrafluoroethylene and hexafluoropropylene.

In yet another aspect, the invention features a composition having a catalyst, such as platinum, capable of catalyzing oxidation of a fuel cell gas, a first material resistant to oxidation up to about 3.0 Volts vs. SHE, such as an oxide, and a non-electrolytic material, such as polytetrafluoroethylene. The catalyst, the first material, and the non-electrolytic material compose a fuel cell electrode.

Other features, objects, and advantages of the invention will be apparent from the drawings, description, and claims.

### DESCRIPTION OF DRAWINGS

FIG. 1 is a partial schematic diagram of an embodiment of a fuel cell system;

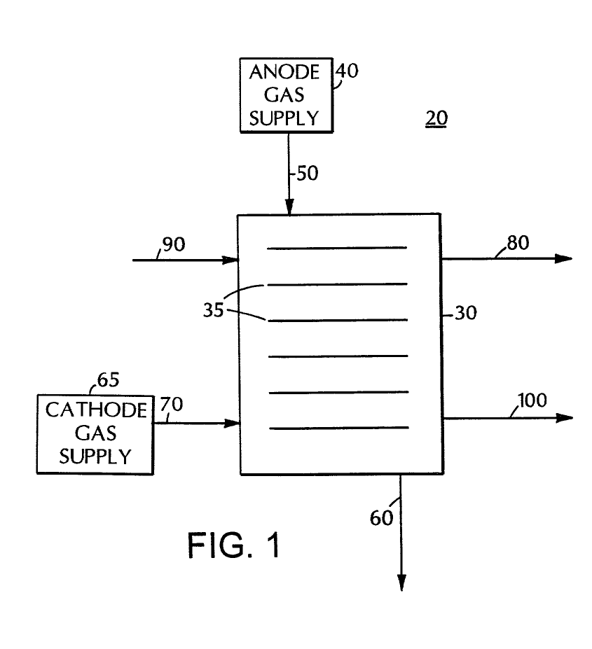

FIG. 2 is a partial schematic diagram of an embodiment of a fuel cell system;

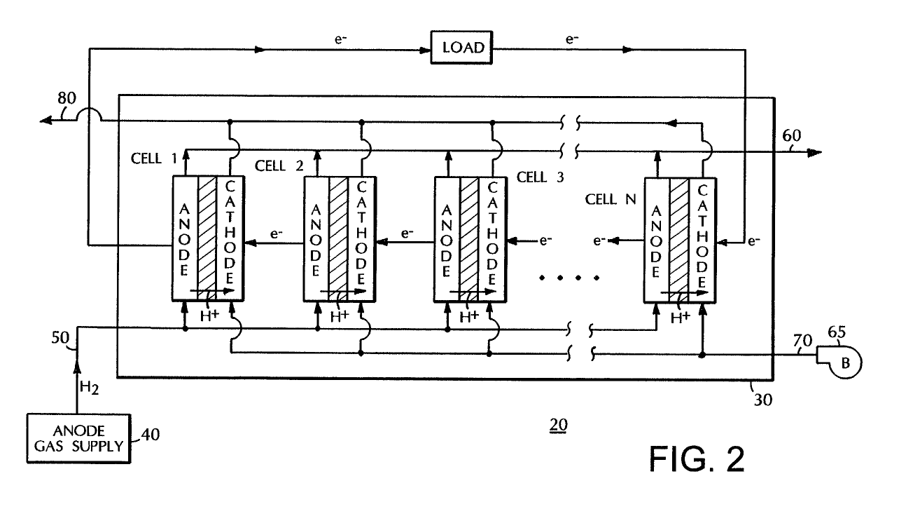

FIG. 3 is a partial cross-sectional view of an embodiment of a fuel cell;

FIG. 4 shows an embodiment of a cathode flow field plate;

FIG. 5 shows an embodiment of an anode flow field plate; and

FIG. 6 shows an embodiment of a coolant flow field plate.

### DETAILED DESCRIPTION OF THE PREFERRED EMBODIMENT

The invention relates to a composition that can be used, for example, in a fuel cell and/or a fuel cell stack.

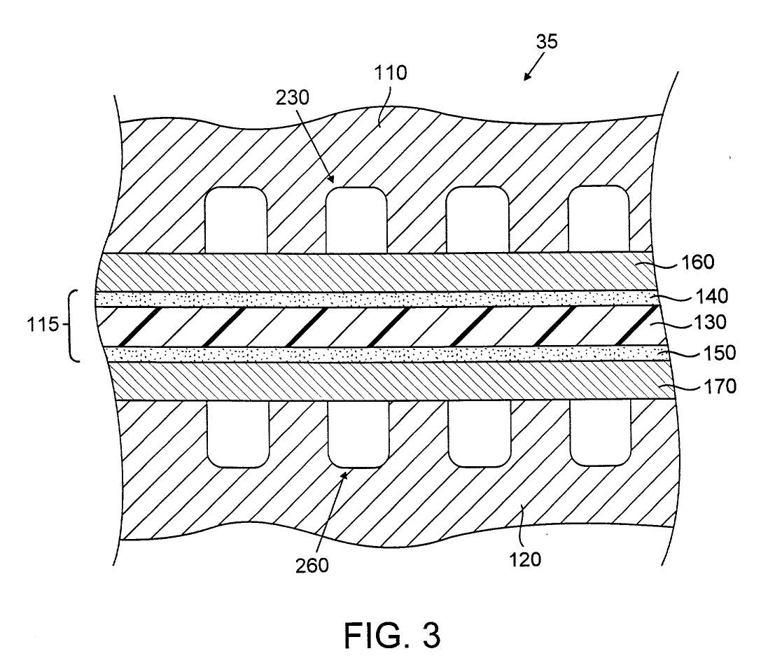

FIG. 3 shows a partial cross-section of fuel cell 35 that includes a cathode flow field plate 110, anode flow field plate 120, a membrane electrode assembly (MEA) 115 having a solid electrolyte 130, cathode catalyst layer 140, and anode catalyst layer 150, and gas diffusion layers (GDLs) 160 and 170. Fuel cells 35 can be arranged by having the back surface of a cathode flow field plate of one fuel cell serve as the anode flow field plate in the next fuel cell. A plurality of coolant flow field plates (described below) can also be used in this arrangement.

Anode catalyst layer 150 includes a catalyst supported on an oxidation-resistant material, and a non-electrolytic material as a binder.

The catalyst in anode catalyst layer 150 is formed of a particulate material tolerant to fuel cell gases and capable of oxidizing a fuel cell gas. For example, the catalyst is not adversely affected by reformate and carbon monoxide, and is capable of interacting with hydrogen to form protons and electrons. The catalyst can undergo reversible oxide formation so that if the catalytic activity of the catalyst is reduced by oxidation and/or passivation, then the catalyst can be re-activated or regenerated by reducing the catalyst, e.g., by heating under hydrogen. Examples of catalysts include platinum, ruthenium, iridium, rhodium, palladium, molybdenum, and alloys of platinum with iridium, rhodium, palladium and molybdenum. Other suitable catalysts are also known. For enhanced catalytic activity, the catalyst particles can have large surface area and/or small particle sizes, e.g., about 20 angstroms.

In certain embodiments, the catalyst is supported on an oxidation-resistant material. Distributing the catalyst on a support material allows the catalytic activity of anode catalyst layer 150 to be maintained at the same level as using bulk, unsupported catalyst, while the total amount of catalyst in anode catalyst layer 150 can be reduced, thereby reducing the cost of forming layer 150. In other words, while less catalyst may be used to form layer 150, a greater fraction of the catalyst is effectively used for the fuel cell reaction, as compared to using bulk, unsupported catalyst. The oxidation-resistant support material is capable of being exposed to a relatively high oxidation potential without being oxidized, e.g., during reformer transients when the potential at the anode can reach about 1.3 to about 1.4 Volts vs. a Standard Hydrogen Electrode (SHE), such as a platinum wire used as a voltage reference that is submersed in hydrogen-saturated sulfuric acid. Examples of oxidation-resistant materials include tungsten oxide, zirconium oxide, niobium oxide, and tantalum oxide. The catalyst can be loaded on the oxidation-resistant support material between about 0.025 mg/cm² to about 1.0 mg/cm².

The catalyst, unsupported or supported on the oxidation-resistant material, is formed into a mechanically-bonded mixture with a non-electrolytic binder. The binder prevents protons from conducting through anode catalyst layer 150. Thus, protons formed by the catalyst that migrate through solid electrolyte 130 to cathode catalyst layer 140 are generally restricted to areas near the anode catalyst layer 150/solid electrolyte 130 interface. Accordingly, the concentration of catalyst located near the anode catalyst layer 150/solid electrolyte 130 interface and/or the load percentage of catalyst on the support material can be increased to provide the desired proton migration to cathode catalyst layer 150. Examples of non-electrolytic materials include fluorine-containing resins such as polytetrafluoroethylene, and copolymers of tetrafluoroethylene and hexafluoropropylene. Anode catalyst layer 150 includes an amount of binder that is sufficient to hold the layer together physically but which does not adversely decrease the electrical conductivity of layer 150. For example, layer 150 can include less than about 30% of the non-electrolytic binder.

Anode catalyst layer 150 is formed by first applying a suspension to a decal, and drying the decal at an elevated temperature. After the decal has dried, it is hot pressed on to a PEM to transfer the anode to the PEM. Alternatively, a suspension is applied to the surfaces of gas diffusion layers (described below) that face solid electrolyte 130, and the suspension is then dried. The method of preparing layer 150 may further include the use of pressure and temperature to achieve bonding.

Referring back to FIG. 3, electrolyte 130 should be capable of allowing ions to flow therethrough while providing a substantial resistance to the flow of electrons. In some embodiments, electrolyte 130 is a solid polymer (e.g., a solid polymer ion exchange membrane), such as a solid polymer proton exchange membrane (e.g., a solid polymer containing sulfonic acid groups). Such membranes are commercially available from E. I. DuPont de Nemours Company (Wilmington, Del.) under the trademark NAFION. Alternatively, electrolyte 130 can also be prepared from the commercial product GORE-SELECT, available from W. L. Gore & Associates (Elkton, Md.).

Cathode catalyst layer 140 can be formed of a material capable of interacting with oxygen, electrons and protons to form water. Examples of such materials include, for example, platinum, platinum alloys, and noble metals dispersed on carbon black. Cathode catalyst layer 140 can be prepared as described above with respect to anode catalyst layer 150.

Gas diffusion layers 160 and 170 are electrically conductive so that electrons can flow from catalyst layer 150 to flow field plate 120 and from flow field plate 110 to cathode catalyst layer 140. GDLs can be formed of a material that is both gas and liquid permeable. It may also be desirable to provide the GDLs with a planarizing layer, as is known in the art, for example, by infusing a porous carbon cloth or paper with a slurry of carbon black followed by sintering with a polytetrafluoroethylene material. Suitable GDLs are available from various companies such as Etek in Natick, Mass., and Zoltek in St. Louis, Mo.

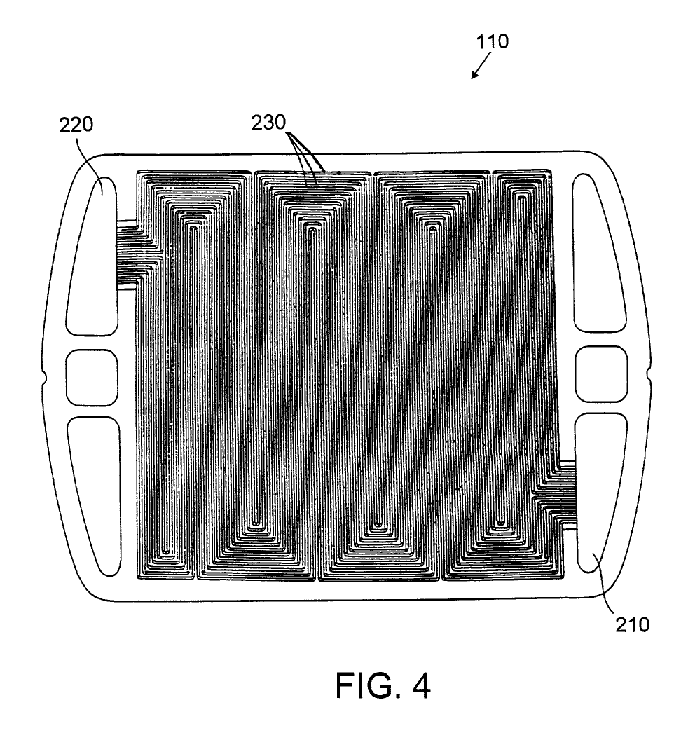

FIG. 4 shows a cathode flow field plate 110 having an inlet 210, an outlet 220, and open-faced channels 230 that define a flow path for a cathode gas from inlet 210 to outlet 220. A cathode gas flows from cathode gas inlet line 70 and enters flow field plate 110 via inlet 210 to cathode outlet line 80. The cathode gas then flows along channels 230 and exits flow field plate 110 via outlet 220. As the cathode gas flows along channels 230, oxygen contained in the cathode gas can permeate gas diffusion layer 160 and interact with catalyst layer 140. Electrons and protons present at layer 140 react with the oxygen to form water. The water can pass back through diffusion layer 160, enter the cathode gas stream in channels 230, and exit plate 110 through cathode flow field plate outlet 220.

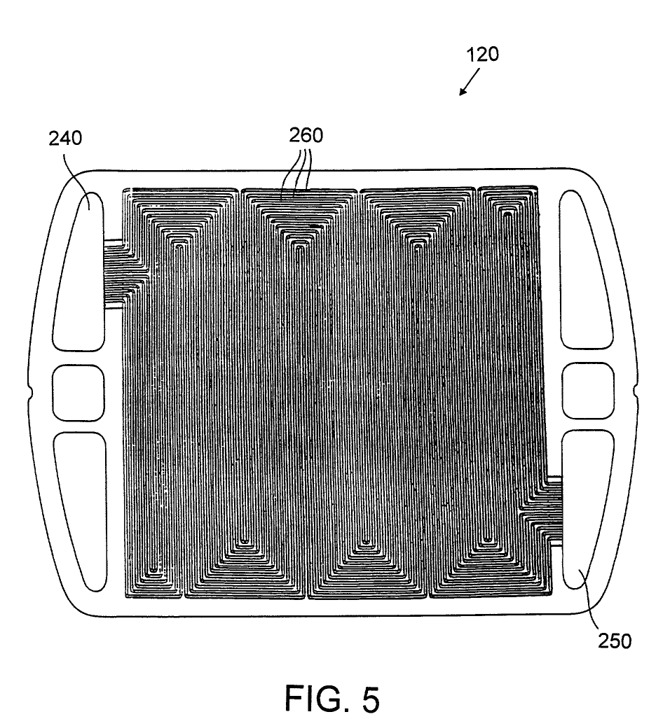

FIG. 5 shows an anode flow field plate 120 having an inlet 240, an outlet 250, and open-faced channels 260 that define a flow path for an anode gas from inlet 240 to outlet 250. An anode gas flows from the anode gas inlet line 50 and enters flow field plate 120 via inlet 240. The anode gas then flows along channels 260 and exits flow field plate 120 via outlet 250 to anode outlet line 60. As the anode gas flows along channels 260, hydrogen contained in the anode gas can permeate gas diffusion layer 170 and interact with catalyst layer 150 to form protons and electrons. The protons pass through solid electrolyte 130, and the electrons are conducted through gas diffusion layer 170 to anode flow field plate 120, ultimately flowing through an external load to cathode flow field plate 110.

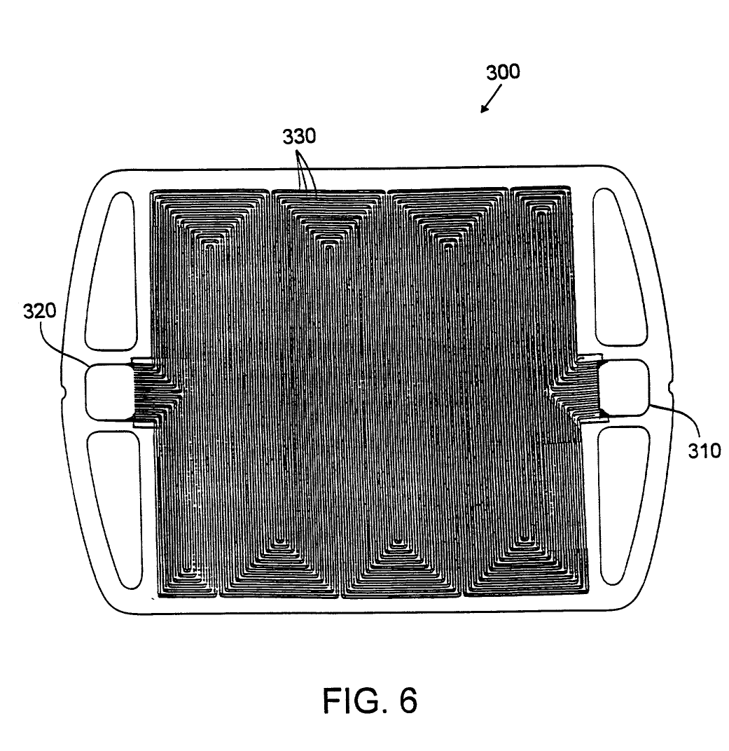

Heat produced during the fuel cell reaction is removed from fuel cell 35 by flowing a coolant through fuel cell 35 via a coolant flow field plate. FIG. 6 shows a coolant flow field plate 300 having an inlet 310, an outlet 320 and open-faced channels 330 that define a flow path for coolant from inlet 310 to outlet 320. The coolant enters fuel cell 35 from coolant inlet line 90 via inlet 310, flows along channels 330 and absorbs heat, and exits fuel cell 35 via outlet 320 to coolant outlet line 100.

Fuel cells 35 are arranged within fuel cell stack 30 such that inlets 240 are configured to be in fluid communication with anode gas inlet line 50, and outlets 250 are configured to be in fluid communication with anode gas outlet line 60. Similarly, inlets 210 are configured to be in fluid communication with cathode gas inlet line 70, and outlets 220 are configured to be in fluid communication with cathode gas outlet line 80. Likewise, inlets 310 are configured to be in fluid communication with coolant inlet line 90, and outlets 320 are configured to be in fluid communication with cathode gas outlet line 100.

While certain embodiments have been described, other embodiments are contemplated. For example, in some embodiments, the anode composition described above can be used in fuel cell systems that use fuel cell gases other than di-hydrogen, e.g., methanol.

Methods of making membrane electrode assemblies and membrane electrode units are known, and are described, for example, in U.S. Pat. No. 5,211,984, which is hereby incorporated by reference.

Other embodiments are in the claims.

What is claimed is:

1. A composition, comprising:
a catalyst; and
a non-electrolytic material different than the catalyst,
wherein the catalyst and the non-electrolytic material compose a fuel cell electrode.

2. The composition of claim 1, wherein the catalyst is capable of catalyzing oxidation of a fuel cell gas.

3. The composition of claim 2, wherein the fuel cell gas comprises hydrogen.

4. The composition of claim 1, wherein the catalyst is capable of undergoing reversible oxide formation.

5. The composition of claim 1, wherein the catalyst is selected from a group consisting of platinum, ruthenium, iridium, rhodium, palladium, molybdenum and alloys thereof.

6. The composition of claim 1, wherein the composition comprises between about 5 percent to about 40 percent of the catalyst.

7. The composition of claim 1, wherein the composition comprises less than about 30 percent of non-electrolytic material by weight.

8. The composition of claim 1, wherein the non-electrolytic material comprises a fluorine-containing resin.

9. The composition of claim 1, wherein the non-electrolytic material comprises a copolymer of tetrafluoroethylene and hexafluoropropylene.

10. The composition of claim 1, wherein the non-electrolytic material comprises polytetrafluoroethylene.

11. The composition of claim 1, further comprising:
a first material resistant to oxidation up to about 3.0 Volts vs. SHE.

12. The composition of claim 11, wherein the catalyst is distributed on the first material.

13. The composition of claim 11, wherein the catalyst is distributed on the first material with a load between about 5 percent and about 95 percent.

14. The composition of claim 11, wherein the first material comprises an oxide.

15. The composition of claim 11, wherein the first material is selected from a group consisting of tungsten oxide, zirconium oxide, niobium oxide, and tantalum oxide.

16. A composition, comprising:
a catalyst; and
a first material resistant to oxidation up to about 3.0 Volts vs. SHE,
wherein the catalyst and the first material compose a fuel cell electrode.

17. The composition of claim 16, wherein the catalyst is distributed on the first material.

18. The composition of claim 16, wherein the catalyst is distributed on the first material with a load between about 5 percent and about 95 percent.

19. The composition of claim 16, wherein the first material comprises an oxide.

20. The composition of claim 16, wherein the first material is selected from a group consisting of tungsten oxide, zirconium oxide, niobium oxide, and tantalum oxide.

21. A composition, comprising:
a catalyst capable of catalyzing oxidation of a fuel cell gas;
a first material resistant to oxidation up to about 3.0 Volts vs. SHE; and
a non-electrolytic material,
wherein the catalyst, the first material, and the non-electrolytic material compose a fuel cell electrode.

22. The composition of claim 21, wherein the catalyst comprises platinum.

23. The composition of claim 21, wherein the first material comprises an oxide.

24. The composition of claim 21, wherein the non-electrolytic material comprises polytetrafluoroethylene.
